(19) United States
(12) Patent Application Publication
(10) Pub. No.: US 2016/0378989 A1
(43) Pub. Date: Dec. 29, 2016

(54) APPARATUS AND METHOD FOR MONITORING ANDROID PLATFORM-BASED APPLICATION

(71) Applicant: ELECTRONICS AND TELECOMMUNICATIONS RESEARCH INSTITUTE, Daejeon (KR)

(72) Inventor: Yeongung PARK, Daejeon (KR)

(21) Appl. No.: 14/939,507

(22) Filed: Nov. 12, 2015

(30) Foreign Application Priority Data
Jun. 25, 2015 (KR) 10-2015-0090559

(51) Int. Cl. G06F 21/56

(52) U.S. Cl. CPC G06F 21/566

(57) ABSTRACT

An apparatus and method for monitoring an Android platform-based application. The apparatus for monitoring an Android platform-based application includes a code list acquisition unit for acquiring a code list of multiple pieces of application code corresponding to applications using an Android-based application package file, a target setting unit for setting at least one piece of target code to be monitored among the multiple pieces of application code, based on the code list, an execution information collection unit for collecting at least one piece of code execution information corresponding to the at least one piece of target code from an Android terminal, and a monitoring information provision unit for generating and providing application monitoring information required in order to perform at least one of detection of malicious code execution and analysis of application behavior, based on the at least one piece of code execution information.

### CROSS REFERENCE TO RELATED APPLICATION

This application claims the benefit of Korean Patent Application No. 10-2015-0090559, filed Jun. 25, 2015, which is hereby incorporated by reference in its entirety into this application.

### BACKGROUND OF THE INVENTION

1. Technical Field

The present invention relates generally to Android-based application monitoring technology and, more particularly, to application monitoring technology, which can analyze the behavior of Android-based applications and detect malicious code in Android terminals by performing monitoring based on application code.

2. Description of the Related Art

The Android platform is a software framework published by the Open Handset Alliance (OHA) and supported by Google. The Android platform is a software package that includes a Linux kernel, a virtual machine, a framework, and applications, and in addition a software development kit is provided for developing Android applications.

Further, there are Android markets for distributing applications to be executed on the Android platform, that is, Android applications. Such Android markets have an open structure in which a developer can freely register Android applications without requiring a special verification procedure, and a user can freely download and use Android applications without requiring a special authentication procedure.

Currently, the use of terminal devices that support the Android operating system and Android applications for the terminal device is continuously increasing. The structure of the conventional Android platform provides only the function of simply executing Android applications. Therefore, a user who uses a smart phone equipped with the Android operating system has the possibility of inadvertently installing an Android application having a malicious purpose, such as the collection and leakage of personal information, the change of system configuration, or the injection of malicious code without being aware of the installation thereof, entailing the possibility of information that is sensitive to an individual or a business being leaked to the outside and being abused via the application having a malicious purpose.

However, the Android platform has to date merely provided a function of simply executing applications, and does not provide a tool or a method for analyzing the behavior of Android applications from outside the applications and determining, via such analysis, whether an Android application is injected with code that behaves maliciously, such as collecting personal information, leaking the collected information to the outside, or changing the system configuration.

Therefore, Android-based application monitoring technology that can collect information on the behavior of an Android application by monitoring the Android application, or can detect whether malicious code that behaves maliciously is injected into the application, is urgently required.

In connection with this, Korean Patent Application Publication No 10-2015-0059882 (Date of publication: Jun. 3, 2015) discloses a technology related to “System and Method for Analyzing Malicious Application of Smart-phone and Service System and Service Method for Blocking Malicious Application of Smart-phone.”

### SUMMARY OF THE INVENTION

Accordingly, the present invention has been made keeping in mind the above problems occurring in the prior art, and an object of the present invention is to determine, based on application monitoring information, whether malicious code is injected into an Android terminal, thus preventing damage such as the leakage of personal information.

Another object of the present invention is to monitor a monitoring target application without requesting any change or modification from the Android operating system on which the application is running.

A further object of the present invention is to track data used by the developer of malicious code by determining behavior information based on application execution information on wired and wireless terminals, analyzing the collection, change or leakage of significant information, and analyzing the information about the execution of code developed by the malicious code developer, thus enabling the analysis of the intention to conduct specific behavior.

Yet another object of the present invention is to verify, in advance, the safety of a limited application that can be accessed and used only by specific members belonging to a public institution or a business.

In accordance with an aspect of the present invention to accomplish the above objects, there is provided an apparatus for monitoring an Android platform-based application, including a code list acquisition unit for acquiring a code list of multiple pieces of application code corresponding to applications using an Android-based application package file; a target setting unit for setting at least one piece of target code to be monitored among the multiple pieces of application code, based on the code list; an execution information collection unit for collecting at least one piece of code execution information corresponding to the at least one piece of target code from an Android terminal; and a monitoring information provision unit for generating and providing application monitoring information required in order to perform at least one of detection of malicious code execution and analysis of application behavior, based on the at least one piece of code execution information.

The execution information collection unit may be configured to, when an application is being subjected to an operation corresponding to at least one of installation, execution, and deletion, insert a collection module into the application using a collection agent installed on the Android terminal, and collect the at least one piece of code execution information via the collection module.

The apparatus may further include an application management unit for acquiring the application package file over Internet and performing at least one of installation, execution, and deletion of an application on the Android terminal based on the application package file.

The application management unit may manage the application using at least one of a class list, a method list, and manifest information included in the application package file.

The code list may include at least one of the class list and the method list.

The at least one piece of target code may correspond to at least one of at least one target class that is set based on the class list and at least one target method that is set based on the method list.

The execution information collection unit may detect a time at which the at least one piece of target code is executed in an execution flow of the application, based on the manifest information, and collects the at least one piece of code execution information in consideration of the time at which the at least one piece of target code is executed.

The collection module may be generated to be divided into a Dalvik Executable (DEX) file that is executed by a Dalvik virtual machine and a shared library of a Linux operating system.

The at least one piece of code execution information may include at least one of an execution time, execution thread information, class information, method information, method factor information, and call stack information.

The monitoring information provision unit may generate the application monitoring information in consideration of at least one of a relationship between pieces of code execution information and a meaning of the at least one piece of target code.

The apparatus may further include an application data insertion unit for, when the application is installed to collect analysis data for analysis of application behavior, insert an analysis module for generating the analysis data into the application.

In accordance with another aspect of the present invention to accomplish the above objects, there is a method for monitoring an Android platform-based application, including acquiring a code list of multiple pieces of application code corresponding to applications using an Android-based application package file; setting at least one piece of target code to be monitored among the multiple pieces of application code, based on the code list; collecting at least one piece of code execution information corresponding to the at least one piece of target code from an Android terminal; and generating and providing application monitoring information required in order to perform at least one of detection of malicious code execution and analysis of application behavior, based on the at least one piece of code execution information.

Collecting the at least one piece of code execution information may include, when an application is being subjected to an operation corresponding to at least one of installation, execution, and deletion, inserting a collection module into the application using a collection agent installed on the Android terminal, wherein the at least one piece of code execution information is collected via the collection module.

The method may further include acquiring the application package file over Internet; and managing the application by performing at least one of installation, execution, and deletion of an application on the Android terminal based on the application package file.

Managing the application may be configured to manage the application using at least one of a class list, a method list, and manifest information included in the application package file.

The code list may include at least one of the class list and the method list.

The at least one piece of target code may correspond to at least one of at least one target class that is set based on the class list and at least one target method that is set based on the method list.

Collecting the at least one piece of code execution information may include detecting a time at which the at least one piece of target code is executed in an execution flow of the application, based on the manifest information, wherein the at least one piece of code execution information is collected in consideration of the time at which the at least one piece of target code is executed.

The at least one piece of code execution information may include at least one of an execution time, execution thread information, class information, method information, method factor information, and call stack information.

The collection module may be generated to be divided into a Dalvik Executable (DEX) file that is executed by a Dalvik virtual machine and a shared library of a Linux operating system.

Providing the application monitoring information may be configured to generate the application monitoring information in consideration of at least one of a relationship between pieces of code execution information and a meaning of the at least one piece of target code.

The method may further include when the application is installed to collect analysis data for analysis of application behavior, inserting an analysis module for generating the analysis data into the application.

In accordance with a further aspect of the present invention to accomplish the above objects, there is provided a system for monitoring an Android platform-based application, including a monitoring apparatus for setting at least one piece of target code among multiple pieces of application code corresponding to applications using an Android-based application package file, and providing monitoring information required in order to perform at least one of detection of malicious code execution and analysis of application behavior, based on at least one piece of code execution information corresponding to the at least one piece of target code; and an Android terminal on which a collection agent for inserting a collection module into the application is installed, the collection module providing the at least one piece of execution code information to the monitoring apparatus.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a system for monitoring an Android platform-based application according to an embodiment of the present invention;

FIG. 2 is a block diagram showing the monitoring apparatus shown in FIG. 1;

FIG. 3 is a diagram conceptually showing the structure of a conventional Android platform;

FIG. 4 is a diagram showing the systematic structure of a monitoring apparatus, a collection agent, and a collection module according to an embodiment of the present invention;

FIG. 5 is a block diagram showing the collection module shown in FIG. 4;

FIG. 6 is a diagram showing the steps of a monitoring method according to an embodiment of the present invention;

FIG. 7 is an operation flowchart showing a method for monitoring an Android platform-based application according to an embodiment of the present invention; and

FIG. 8 is a diagram showing a process for monitoring an Android platform-based application according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, preferred embodiments of the present invention will be described in detail with reference with the attached drawings.

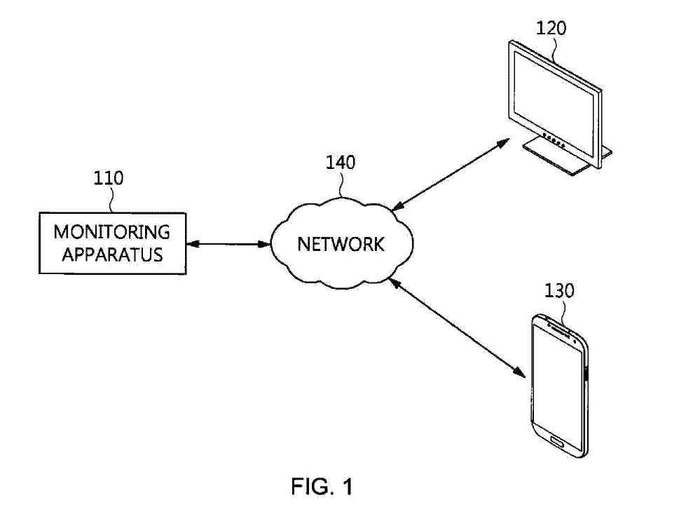

FIG. 1 is a block diagram showing a system for monitoring an Android platform-based application according to an embodiment of the present invention.

Referring to FIG. 1, the Android platform-based application monitoring system according to the embodiment of the present invention includes a monitoring apparatus 110, Android terminals 120 and 130, and a network 140.

The monitoring apparatus 110 may acquire an application package file over the Internet and perform at least one of the installation, execution, and deletion of an application on the Android terminals 120 and 130, based on the application package file.

Here, applications may be managed using at least one of a class list, a method list, and manifest information, which are included in the application package file.

The monitoring apparatus 110 may insert an analysis module for generating analysis data into an application when the application is installed so as to collect analysis data for the analysis of application behavior.

The monitoring apparatus 110 may acquire a code list including multiple pieces of application code corresponding to applications using an Android-based application package file.

Here, the code list may include at least one of a class list and a method list.

The monitoring apparatus 110 may set at least one piece of target code to be monitored among multiple pieces of application code, based on the code list.

Here, at least one piece of target code may correspond to at least one of at least one target class, which is set based on the class list, and at least one target method, which is set based on the method list.

The monitoring apparatus 110 may collect at least one piece of code execution information corresponding to at least one piece of target code from the Android terminals 120 and 130.

Here, when the application is currently being subjected to an operation corresponding to at least one of installation, execution, and deletion, a collection module is inserted into the application using a collection agent installed on the Android terminal 120 or 130, and at least one piece of code execution information may be collected using the collection module.

In this case, the time at which at, least one piece of target code is executed in the execution flow of the application is detected based on the manifest information, and at least one piece of code execution information may be collected in consideration of the time at which the at least one piece of target code is executed.

Here, the collection module may be generated to be divided into a Dalvik Executable (DEX) file executed by a Dalvik virtual machine and, a shared library of a Linux operating system.

The at least one piece of code execution information may include at least one of an execution time, execution thread information, class information, method information, method factor information, and call stack information.

The monitoring apparatus 110 may generate and provide application monitoring information required in order to perform at least one of the detection of the execution of malicious code and the analysis of application behavior, based on the at least one piece of code execution information.

Here, application monitoring information may be generated in consideration of at least one of the relationship between pieces of code execution information and the meaning of at least one piece of target code.

Each of the Android terminals 120 and 130 may be an Android platform-based wired or wireless terminal.

Here, each of the Android terminals 120 and 130 may receive a collection agent from the monitoring apparatus 110 and install it therein.

In this case, in each of the Android terminals 120 and 130, the installation, execution or deletion of an application may be performed under the control of the monitoring apparatus 110.

In this case, when an application is currently running on the Android terminal 120 or 130, the collection module included in the collection agent may be inserted into the application to collect the information about the execution of the application.

Here, the collection module may transfer the collected information to the monitoring apparatus 110.

The network 140 is configured to provide a path through which data is transferred between the monitoring apparatus 110 and the Android terminal 120 or 130, and is a concept including all of an existing network and a network that can be developed in the future. For example, the network 140 may be any of a wired/wireless local area network for providing communication between various types of information devices in a limited area, a mobile communication network for providing communication between moving objects and between a moving object and an external system thereof, a satellite communication network for providing communication between individual earth stations using a satellite, or any one wired/wireless communication network, or a combination of such networks. Meanwhile, the transmission scheme standard of the network 140 is not limited to any existing transmission scheme, and may include all transmission scheme standards which will be developed in the future.

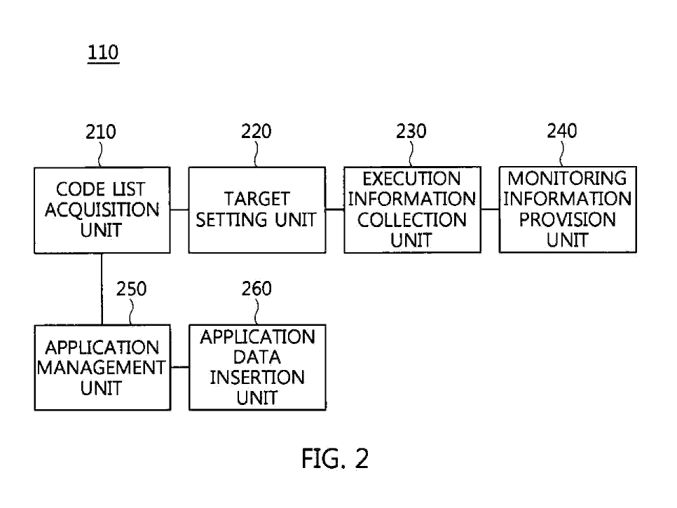

FIG. 2 is a block diagram showing the monitoring apparatus shown in FIG. 1.

Referring to FIG. 2, the monitoring apparatus 110 shown in FIG. 1 includes a code list acquisition unit 210, a target setting unit 220, an execution information collection unit 230, a monitoring information provision unit 240, an application management unit 250, and an application data insertion unit 260.

Here, the monitoring apparatus 110 may be a device or a program that is running on a personal computer based on an operating system such as Windows or Linux. Further, the monitoring apparatus 110 may be a device or a program for extracting and analyzing the information about the execution of the Android application that is executed on an Android-based smart device or that is executed via an Android emulator running on the Windows or Linux operating system, and for generating the information about the behavior of the application.

Here, the monitoring apparatus 110 may request neither change nor modification from the Android operating system on which the target application that desires to extract information is running. This may be different from a scheme in which conventional systems for dynamically analyzing Android applications have configured the environment in which the information about the behavior of an application is analyzed by changing or modifying the components of the Android platform.

Further, the monitoring apparatus 110 may take the form of an application that runs in a wired terminal environment, and may internally include a code list acquisition unit 210, a target setting unit 220, an execution information collection unit 230, a monitoring information provision unit 240, an application management unit 250, and an application data insertion unit 260.

The code list acquisition unit 210 may acquire a code list of multiple pieces of application code corresponding to applications, using an Android-based application package file.

Here, the application package file may correspond to an installation file for an application that is executable on the Android operating system. For example, an apk (Android package) may correspond to the application package file.

Further, the application package file may include information about all classes and methods that are defined or used in the application.

Furthermore, the application package file may include manifest information in which components constituting an application and intent to which the components respond are defined. Here, information about the application and the start point of the application may be collected based on the manifest information.

Here, the code list may include at least one of a class list and a method list. That is, the class list and the method list, in which information about all classes and all methods of the application that can be the target of monitoring is included, may be included in the code list required to set the monitoring target.

The target setting unit 220 may set at least one piece of target code to be monitored among multiple pieces of application code based on the code list. For example, information about all classes and methods that are defined or used in the application via the code list is acquired, and a target that is desired to be tracked and monitored may be set among the acquired classes and methods.

Here, at least one piece of target code may correspond to at least one of at least one target class that is set based on the class list and at least one target method that is set based on the method list.

For the class or method which is set as the target to be monitored In this way, related execution information may be collected when the application is being executed in real time, or may be read by a manager who uses the monitoring apparatus.

The execution information collection unit 230 may collect at least one piece of code execution information corresponding to at least one piece of target code from the Android terminals.

When the application is being subjected to an operation corresponding to at least one of installation, execution, and deletion, the collection module may be inserted into the application using the collection agent installed on each Android terminal, and at least one piece of code execution information may be collected via the collection module. For example, when the class and method for running the application may be executed as in the case where the application is being installed, executed, or deleted, the collection module may be dynamically inserted into the application, and then code execution information based on the execution of the class or method that is set as the target may be collected.

Here, the collection agent may correspond to an Android application including the collection module inserted into the Android application. Therefore, the collection agent may be installed in advance on the Android terminal through the monitoring apparatus.

That is, during the execution of the application, the collection agent generates the collection module and inserts the generated collection module into the application, thus enabling an environment to be constructed such that the code execution information corresponding to the target code of the application can be extracted.

Here, the time at which at least one piece of target code is executed in the execution flow of the application is detected based on the manifest information, and at least one piece of code execution information may be collected in consideration of the time at which at least one piece of target code is executed. For example, if it is assumed that the class that is set as the monitoring target code is used when an application is executed after being installed, the collection module is inserted into the application and executed when the class set as the target code is intended to be executed. Accordingly, the structure and values of the class set as the target code may be automatically analyzed, and then code execution information may be collected.

Here, at least one piece of code execution information may include at least one of an execution time, execution thread information, class information, method information, method factor information, and call stack information. That is, after the application has been executed, when the flow of execution corresponds to the execution of the class or method that is set as the target code, information such as the execution time, the executed thread information, class information, method information, method factor information, and call stack information may be collected and loaded to the monitoring apparatus. Since such an information collection scheme is implemented without changing the Android platform that is the target of information collection, there is no need to modify the monitoring apparatus or the monitoring program in response to the version upgrade or functional enhancement of respective Android platforms, thus improving efficiency.

In this case, the collection module may be generated to be divided into a DEX file executed by the Dalvik virtual machine and the shared library of a Linux operating system.

Here, the Dalvik virtual machine may be a register machine-type virtual machine, and may have been optimized for low memory requirement specifications, and thus may be used in Android platform-based mobile terminals. Further, there may occur the case where the Dalvik virtual machine is occasionally confused with a Java virtual machine, but the Dalvik virtual machine uses the dx tool, provided together with the Android Software Development Kit (SDK), rather than using Java bytecode. Accordingly, Java class files may be converted into a Dalvik Executable (DEX) file format.

The monitoring information provision unit 240 may generate and provide application monitoring information required in order to perform at least one of the detection of malicious code execution and the analysis of application behavior, based on at least one piece of code execution information.

For example, it is possible to detect the execution of malicious code by determining whether, malicious behavior, such as an operation of collecting information about the user of an Android terminal and leaking the user information to the outside, or an operation of changing system configuration, is included in the code execution information of target code. Further, it is also possible to verify safety in advance by opening an application, which is otherwise limitedly and internally used by members of a public institution or business, to the public, and analyzing the behavior of the application before the application is used.

Here, the application monitoring information may be generated in consideration of at least one of the relationship between pieces of code execution information and the meaning of at least one piece of target code. For example, when the code execution information of a class corresponding to the target code is collected, information may be processed and generated so that the user who uses the monitoring apparatus may summarize and view the behavior of the application via the execution of the class.

The application management unit 250 may acquire an application package file over the Internet and may perform at least one of installation, execution, and deletion of an application on the Android terminal, based on the application package file.

In this case, the application may be managed using at least one of a class list, a method list, and manifest information, which are included in the application package file. Therefore, the start point of the application corresponding to the application package file is detected based on the manifest information, and the installation, execution and deletion of the application may be performed using the class, method, and application information required for the installation, execution, and deletion of the application.

The application data insertion unit 260 may insert an analysis module for generating analysis data into the application when the application is installed so as to collect analysis data required for the analysis of application behavior. For example, if a file having specific information must be present in order to collect code execution information for a specific application, a file having specific information is automatically generated at the step of installing the application, thus enabling the application to exhibit its own inherent behavior.

Here, the analysis module may correspond to code for performing an operation of generating analysis data.

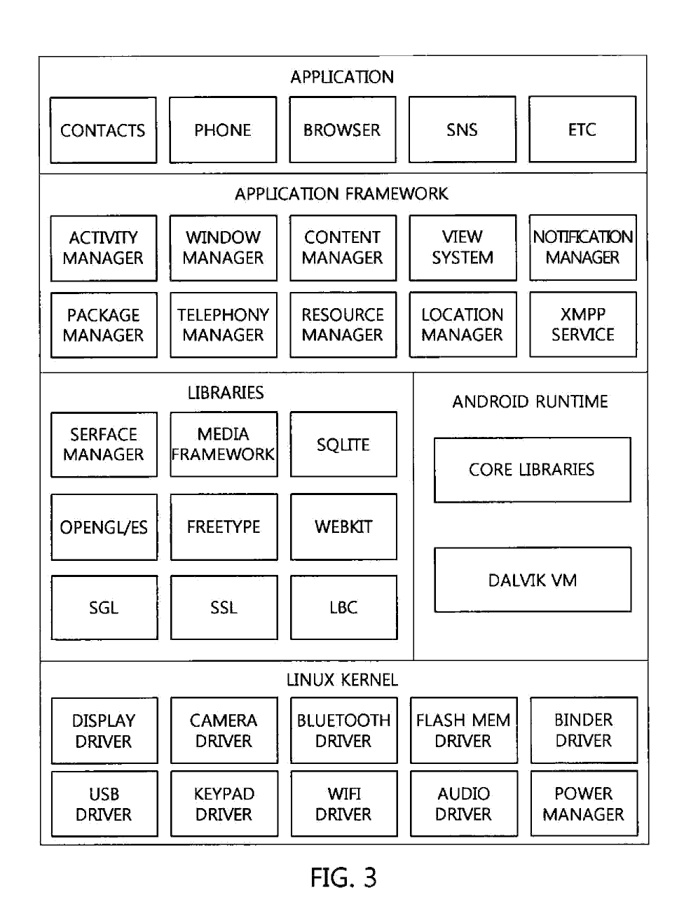

FIG. 3 is a diagram conceptually showing the structure of a conventional Android platform.

Referring to FIG. 3, the conventional Android platform may provide only a function of simply executing Android applications. Therefore, there is a strong possibility that the user who uses a smart phone and a smart pad on which the Android operating system is installed will inadvertently install an Android application having a malicious purpose of collecting and leaking personal information, changing system configuration, and injecting malicious code, without being aware of the installation thereof.

Further, there is a strong possibility that information that is sensitive to an individual or business will be leaked to the outside and be abused via the application having a malicious purpose.

Therefore, as in the case of the present invention, when an application is executed on a smart phone and a smart pad on which the Android operating system is installed, the collection module may be inserted into the application to collect information about behavior related to the execution of the application, thus detecting whether malicious code that applies malicious behavior to the user is injected into the application.

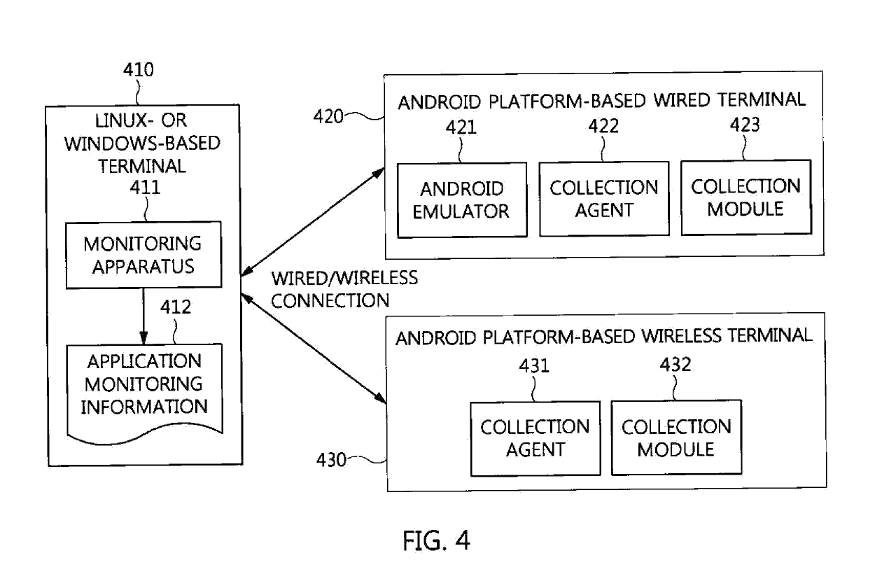

FIG. 4 is a diagram showing the systematic structure of the monitoring apparatus, the collection agent, and the collection module according to an embodiment of the present invention.

Referring to FIG. 4, a monitoring apparatus 411 according to an embodiment of the present invention may be executed via a Linux or Windows-based analysis terminal 410.

Here, the monitoring apparatus 411 may correspond to a device or a program running on a PC based on the Linux or Windows operating system.

Therefore, the analysis terminal 410 for driving the monitoring apparatus 411 may be connected to at least one of an Android wired terminal 420 and an Android wireless terminal 430 via wired/wireless communication, and may perform monitoring.

Here, the Android wired terminal 420 may execute an application via an Android emulator 421 running on a Windows or Linux OS. Therefore, when the application is executed via the Android emulator 421, a collection agent 422 generates a collection module 423 and inserts it into the application, thus acquiring the information about the execution of the application.

Further, the Android wireless terminal 430 may execute the application based on the Android platform of the Android wireless terminal 430 without requiring the Android emulator 421. Therefore, when the application is executed, a collection agent 431 generates a collection module 432 and inserts it into the application in the same manner as the Android wired terminal 420, thus acquiring the information about the execution of the application.

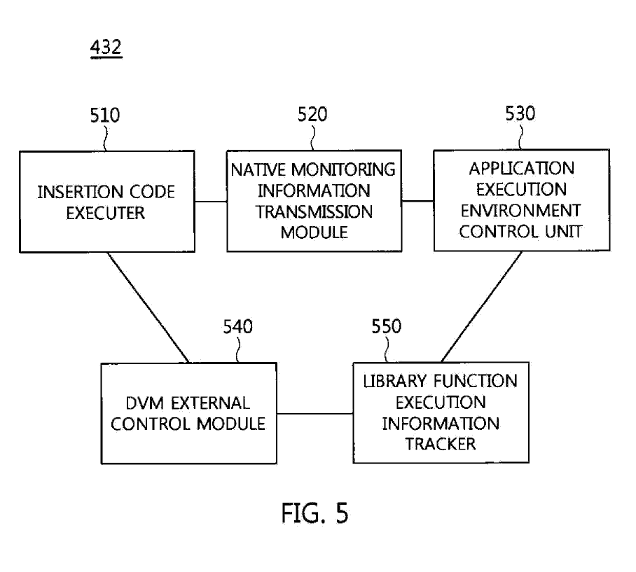

FIG. 5 is a block diagram showing the collection module shown in FIG. 4.

Referring to FIG. 5, the collection module 432 shown in FIG. 4 may include an insertion code executer 510, a native monitoring information transmission module 520, an application execution environment control unit 530, a Dalvik Virtual Machine (DVM) external control module 540, and a library function execution information tracker 550.

The insertion code executer 510 may determine whether to operate the collection module 432 in response to a specific signal from a program in the PC after the collection module 432 has been injected into the application during the execution of the application.

The native monitoring information transmission module 520 is configured to, when the collection module 432 collects the behavior of the application written in native code corresponding to the C language in the Android-based application, transfer the collected information to the program on the PC. That is, the Android application may be composed of a part written in the Java language and a native code part written in the C language. Among these parts, the behavior of the application written in the native code may be tracked and the information thereof may be collected. Here, a means for transferring the collected information may be the native monitoring information transmission module 520.

When the collection module 432 is inserted into the running application, the application execution environment control unit 530 may revise pieces of information that may influence the execution of the application in the memory of the application. That is, the collection module 432 in the memory of the application may correspond to a module for collecting and manipulating pieces of information that may influence the execution of the application.

Android applications may be executed by a code interpreter called a “Dalvik Virtual Machine (DVM)”, and the code interpretation behavior of DVM may be fabricated via the DVM external control module 540 when the DVM interprets the code of the application. For example, when the DVM interprets code, the DVM external control module 540 may prevent a specific function from being executed or may block the termination of the DVM when it is intended to terminate the DVM.

The library function execution information tracker 550 may track and collect the execution information of functions that are used when the part written in the C language is executed in the Android-based application, and may then track which service of the Android operating system is used.

In this case, the part of the Android application written in the C language may use functions provided by a module called libc (C library) so as to use services provided by the OS, such as file reading and writing and network communication, during the execution of the application. Therefore, the service information of the OS used by functions provided by the libc module may be collected. In this case, the OS services may include file opening, file reading, file writing, network communication, and file authority change.

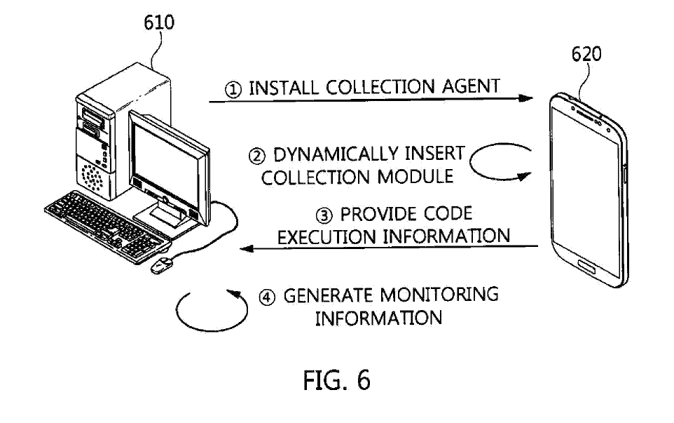

FIG. 6 is a diagram showing the steps of the monitoring method according to an embodiment of the present invention.

Referring to FIG. 6, in the monitoring method according to the embodiment of the present invention, an analysis terminal 610 for monitoring an application may operate the monitoring apparatus and install a collection agent in an Android terminal 620. For example, when a Uniform Resource Locator (URL) address enabling the collection agent to be installed is provided via wireless communication, the Android terminal 620 may install the collection agent based on the URL address.

Thereafter, when an operation corresponding to at least one of installation, execution, and deletion of an application is performed on the Android terminal 620 under the control of the analysis terminal 610, the collection agent may generate a collection module and dynamically insert the collection module into the platform of the Android terminal 620.

Next, the collection module inserted into the platform of the Android terminal 620 provides code execution information collected based on the execution of the application to the analysis terminal 610, thus allowing the monitoring apparatus to acquire the code execution information.

Thereafter, the monitoring apparatus of the analysis terminal 610 may generate application monitoring information based on the code execution information. Here, the monitoring apparatus may show the application monitoring information to the user or a monitoring analyst via the display device of the analysis terminal 610.

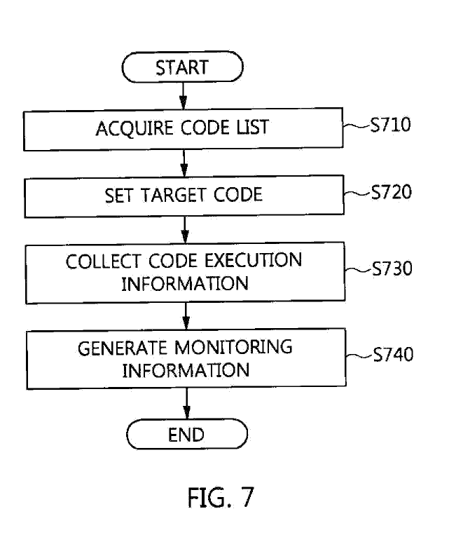

FIG. 7 is an operation flowchart showing a method for monitoring an Android platform-based application according to an embodiment of the present invention.

The monitoring apparatus 110 may be a device or a program that is running on a personal computer based on an operating system such as Windows or Linux. Further, the monitoring apparatus 110 may be a device or a program for extracting and analyzing the information about the execution of the Android application that is executed on an Android-based smart device or that is executed via an Android emulator running on the Windows or Linux operating system, and for generating the information about the behavior of the application.

Here, the monitoring method may request neither change nor modification from the Android operating system on which the target application that desires to extract information is running. This may be different from a scheme in which conventional systems for dynamically analyzing Android applications have configured the environment in which the information about the behavior of an application is analyzed by changing or modifying the components of the Android platform.

Referring to FIG. 7, the method for monitoring an Android platform-based application according to the embodiment of the present invention may acquire a code list of multiple pieces of application code corresponding to applications, using an Android-based application package file at step S710.

Here, the application package file may correspond to an installation file for an application that is executable on the Android operating system. For example, an apk (Android package) may correspond to the application package file.

Further, the application package file may include information about all classes and methods defined or used in the application.

Furthermore, the application package file may include manifest information in which components constituting an application and intent to which the components respond are defined. Here, information about the application and the start point of the application may be collected based on the manifest information.

Here, the code list may include at least one of a class list and a method list. That is, the class list and the method list, in which information about all classes and all methods of the application that can be the target of monitoring is included, may be included in the code list required to set the monitoring target.

Further, the method for monitoring an Android platform-based application according to the embodiment of the present invention may set at least one piece of target code to be monitored among multiple pieces of application code, based on the code list at step S720. For example, information about all classes and methods that are defined or used in the application via the code list is acquired, and a target that is desired to be tracked and monitored may be set among the acquired classes and methods.

Here, at least one piece of target code may correspond to at least one of at least one target class that is set based on the class, list and at least one target method that is set based on the method list.

For the class or method which is set as the target to be monitored In this way, related execution information may be collected when the application is being executed in real time, or may be read by a manager who uses the monitoring apparatus.

Meanwhile, the method for monitoring an Android platform-based application according to the embodiment of the present invention may collect at least one piece of code execution information corresponding to at least one piece of target code on the Android terminal at step S730.

When the application is being subjected to an operation corresponding to at least one of installation, execution, and deletion, the collection module may be inserted into the application using the collection agent installed on each Android terminal, and at least one piece of code execution information may be collected via the collection module. For example, when the class and method for running the application may be executed as in the case where the application is being installed, executed, or deleted, the collection module may be dynamically inserted into the application, and then code execution information based on the execution of the class or method that is set as the target may be collected.

Here, the collection agent may correspond to an Android application including the collection module inserted into the Android application. Therefore, the collection agent may be installed in advance on the Android terminal through the monitoring apparatus.

That is, during the execution of the application, the collection agent generates the collection module and inserts the generated collection module into the application, thus enabling an environment to be constructed such that the code execution information corresponding to the target code of the application can be extracted.

The time at which at least one piece of target code is executed in the execution flow of the application is detected based on the manifest information, and at least one piece of code execution information may be collected in consideration of the time at which at least one piece of target code is executed. For example, if it is assumed that the class that is set as the monitoring target code is used when an application is executed after being installed, the collection module is inserted into the application and executed when the class set as the target code is intended to be executed. Accordingly, the structure and values of the class set as the target code may be automatically analyzed, and then code execution information may be collected.

Here, at least one piece of code execution information may include at least one of an execution time, execution thread information, class information, method information, method factor information, and call stack information. That is, after the application has been executed, when the flow of execution corresponds to the execution of the class or method that is set as the target code, information such as the execution time, the executed thread information, class information, method information, method factor information, and call stack information may be collected and loaded to the monitoring apparatus. Since such an information collection scheme is implemented without changing the Android platform that is the target of information collection, there is no need to modify the monitoring apparatus or the monitoring program in response to the version upgrade or functional enhancement of respective Android platforms, thus improving efficiency.

In this case, the collection module may be generated to be divided into a DEX file executed by the Dalvik virtual machine and the shared library of a Linux operating system.

Here, the Dalvik virtual machine may be a register machine-type virtual machine, and may have been optimized for low memory requirement specifications, and thus may be used in Android platform-based mobile terminals. Further, there may occur the case where the Dalvik virtual machine is occasionally confused with a Java virtual machine, but the Dalvik virtual machine uses a dx tool, provided together with the Android Software Development Kit (SDK), rather than using Java bytecode. Accordingly, Java class files may be converted into a DEX file format.

Further, the method for monitoring an Android platform-based application according to the embodiment of the present invention may generate and provide application monitoring information required in order to perform at least one of the detection of malicious code execution and the analysis of application behavior, based on at least one piece of code execution information at step S740.

For example, it is possible to detect the execution of malicious code by determining whether malicious behavior, such as an operation of collecting information about the user of an Android terminal and leaking the user information to the outside, or an operation of changing system configuration, is included in the code execution information of target code. Further, it is also possible to verify safety in advance by opening an application, which is otherwise limitedly and internally used by members of a public institution or business, to the public, and analyzing the behavior of the application before the application is used.

Here, the application monitoring information may be generated in consideration of at least one of the relationship between pieces of code execution information and the meaning of at least one piece of target code. For example, when the code execution information of a class corresponding to the target code is collected, information may be processed and generated so that the user who uses the monitoring apparatus may summarize and view the behavior of the application via the execution of the class.

Further, although not shown in FIG. 7, the method for monitoring an Android platform-based application according to the embodiment of the present invention may acquire an application package file over the Internet, and may perform at least one of the installation, execution, and deletion of the application on the Android terminal, based on the application package file.

In this case, the application may be managed using at least one of a class list, a method list, and manifest information, which are included in the application package file. Therefore, the start point of the application corresponding to the application package file is detected based on the manifest information, and the installation, execution and deletion of the application may be performed using the class, method, and application information required for the installation, execution, and deletion of the application.

Further, although not shown in FIG. 7, the method for monitoring an Android platform-based application according to the embodiment of the present invention may insert an analysis module for generating analysis data into the application when the application is installed so as to collect analysis data required for the analysis of application behavior. For example, if a file having specific information must be present in order to collect code execution information for a specific application, a file having specific information is automatically generated at the step of installing the application, thus enabling the application to exhibit its own inherent behavior.

In this case, the analysis module may correspond to code required to perform an operation of generating analysis data.

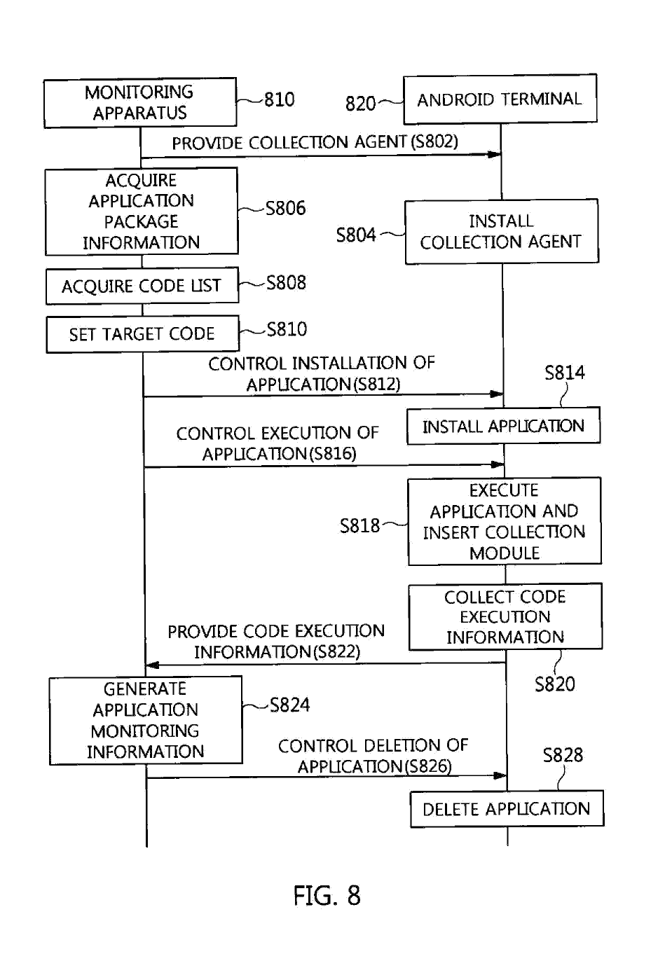

FIG. 8 is a flow diagram showing a process for monitoring an Android platform-based application according to an embodiment of the present invention.

Referring to FIG. 8, in the process for monitoring an Android platform-based application according, to the embodiment of the present invention, a monitoring apparatus 810 may provide a collection agent to an Android terminal 820 at step S802.

Thereafter, the Android terminal 820 may install a collection agent at step S804.

The monitoring apparatus 810 may acquire application package information (application package file) for the application to be monitored over the Internet at step S806.

Thereafter, a code list of multiple pieces of application code corresponding to applications may be acquired based on the application package information at step S808.

Here, an application package file may correspond to an installation file for an application executable on the Android OS. For example, an Android package (apk) may correspond to the application package file.

Further, the application package file may include information about all classes and methods defined or used in the application.

Here, the code list may include at least one of a class list and a method list.

Thereafter, at least one piece of target code which is to be monitored among multiple pieces of application code may be set based on the code list at step S810.

Here, at least one piece of target code may correspond to at least one of at least one target class that is set based on the class list and at least one target method that is set based on the method list.

Thereafter, the monitoring apparatus 810 may perform control such that the application is installed on the Android terminal 820 using application package information at step S812.

Next, when the application is installed on the Android terminal 820 at step S814, the monitoring apparatus 810 may perform control such that the application installed on the Android terminal 820 is executed at step S816.

Thereafter, when the application is executed on the Android terminal 820, the collection agent installed on the Android terminal 820 may generate a collection module and insert it into the application at step S818.

Here, the collection module may be generated to be divided into a DEX file executed by a Dalvik virtual machine and the shared library of the Linux operating system.

Next, at least one piece of code execution information corresponding to at least one piece of target code may be collected using the collection module at step S820.

Here, the time at which at least one piece of target code is executed in the execution flow of the application is detected based on the manifest information, and at least one piece of code execution information may be collected in consideration of the time at which at least one piece of target code is executed.

The at least one piece of code execution information may include at least one of an execution time, execution thread information, class information, method information, method factor information, and call stack information.

Thereafter, at least one piece of code execution information may be provided to the monitoring apparatus 810 using the collection module at step S822.

Thereafter, the monitoring apparatus 810 may generate application monitoring information required in order to perform at least one of the detection of malicious code execution and the analysis of application behavior using the at least one piece of code execution information at step S824.

The application monitoring information may be generated in consideration of at least one of the relationship between pieces of code execution information and the meaning of at least one piece of target code.

Thereafter, the monitoring apparatus 810 may perform control such that the application is deleted from the Android terminal 820 using the application package information at step S826, and the Android terminal 820 may delete the application at step S828.

In accordance with the present invention, the present invention may determine, based on application monitoring information, whether malicious code is injected into an Android terminal, thus preventing damage such as the leakage of personal information.

Further, the present invention may monitor a monitoring target application without requesting any change or modification from the Android operating system on which the application is running.

Furthermore, the present invention may track data used by the developer of malicious code by determining behavior information based on application execution information on wired and wireless terminals, analyzing the collection, change or leakage of significant information, and analyzing the information about the execution of code developed by the malicious code developer, thus enabling the analysis of the intention to conduct specific behavior.

Furthermore, the present invention may verify, in advance, the safety of a limited application that can be accessed and used only by specific members belonging to a public institution or a business.

As described above, in the apparatus and method for monitoring an Android platform-based application according to the present invention, the configurations and schemes in the above-described embodiments are not limitedly applied, and some or all of the above embodiments can be selectively combined and configured so that various modifications are possible.

What is claimed is:

1. An apparatus for monitoring an Android platform-based application, comprising:
a code list acquisition unit for acquiring a code list of multiple pieces of application code corresponding to applications using an Android-based application package file;
a target setting unit for setting at least one piece of target code to be monitored among the multiple pieces of application code, based on the code list;
an execution information collection unit for collecting at least one piece of code execution information corresponding to the at least one piece of target code from an Android terminal; and
a monitoring information provision unit for generating and providing application monitoring information required in order to perform at least one of detection of malicious code execution and analysis of application behavior, based on the at least one piece of code execution information.

2. The apparatus of claim 1, wherein the execution information collection unit is configured to, when an application is being subjected to an operation corresponding to at least one of installation, execution, and deletion, insert a collection module into the application using a collection agent installed on the Android terminal, and collect the at least one piece of code execution information via the collection module.

3. The apparatus of claim 1, further comprising an application management unit for acquiring the application package file over Internet and performing at least one of installation, execution, and deletion of an application on the Android terminal based on the application package file.

4. The apparatus of claim 3, wherein the application management unit manages the application using at least one of a class list, a method list, and manifest information included in the application package file.

5. The apparatus of claim 4, wherein the code list comprises at least one of the class list and the method list.

6. The apparatus of claim 5, wherein the at least one piece of target code corresponds to at least one of at least one target class that is set based on the class list and at least one target method that is set based on the method list.

7. The apparatus of claim 4, wherein the execution information collection unit detects a time at which the at least one piece of target code is executed in an execution flow of the application, based on the manifest information, and collects the at least one piece of code execution information in consideration of the time at which the at least one piece of target code is executed.

8. The apparatus of claim 2, wherein the collection module is generated to be divided into a Dalvik Executable (DEX) file that is executed by a Dalvik virtual machine and a shared library of a Linux operating system.

9. The apparatus of claim 1, wherein the at least one piece of code execution information comprises at least one of an execution time, execution thread information, class information, method information, method factor information, and call stack information.

10. The apparatus of claim 1, wherein the monitoring information provision unit generates the application monitoring information in consideration of at least one of a relationship between pieces of code execution information and a meaning of the at least one piece of target code.

11. The apparatus of claim 3, further comprising an application data insertion unit for, when the application is installed to collect analysis data for analysis of application behavior, insert an analysis module for generating the analysis data into the application.

12. A method for monitoring an Android platform-based application, comprising:
acquiring a code list of multiple pieces of application code corresponding to applications using an Android-based application package file;
setting at least one piece of target code to be monitored among the multiple pieces of application code, based on the code list;
collecting at least one piece of code execution information corresponding to the at least one piece of target code from an Android terminal; and
generating and providing application monitoring information required in order to perform at least one of detection of malicious code execution and analysis of application behavior, based on the at least one piece of code execution information.

13. The method of claim 12, wherein collecting the at least one piece of code execution information comprises:
when an application is being subjected to an operation corresponding to at least one of installation, execution, and deletion, inserting a collection module into the application using a collection agent installed on the Android terminal,
wherein the at least one piece of code execution information is collected via the collection module.

14. The method of claim 12, further comprising:
acquiring the application package file over Internet; and
managing the application by performing at least one of installation, execution, and deletion of an application on the Android terminal based on the application package file.

15. The method of claim 14, wherein managing the application is configured to manage the application using at least one of a class list, a method list, and manifest information included in the application package file.

16. The method of claim 15, wherein the code list comprises at least one of the class list and the method list.

17. The method of claim 16, wherein the at least one piece of target code corresponds to at least one of at least one target class that is set based on the class list and at least one target method that is set based on the method list.

18. The method of claim 15, wherein collecting the at least one piece of code execution information comprises:
detecting a time at which the at least one piece of target code is executed in an execution flow of the application, based on the manifest information,
wherein the at least one piece of code execution information is collected in consideration of the time at which the at least one piece of target code is executed.

19. The method of claim 12, wherein the at least one piece of code execution information comprises at least one of an execution time, execution thread information, class information, method information, method factor information, and call stack information.

20. A system for monitoring an Android platform-based application, comprising:
a monitoring apparatus for setting at least one piece of target code among multiple pieces of application code corresponding to applications using an Android-based application package file, and providing monitoring information required in order to perform at least one of detection of malicious code execution and analysis of application behavior, based on at least one piece of code execution information corresponding to the at least one piece of target code; and
an Android terminal on which a collection agent for inserting a collection module into the application is installed, the collection module providing the at least one piece of execution code information to the monitoring apparatus.
